(19) United States
(12) Patent Application Publication
(10) Pub. No.: US 2004/0033929 A1
(43) Pub. Date: Feb. 19, 2004

(54) Use of water-soluble or water-dispersible polyether blocks cotaining graft polymers as coating for washing, cleaning and for the treatment of laundry

(76) Inventors: Werner Bertleff, Viernheim (DE); Michael Gotsche, Mannheim (DE); Karl Kolter, Limburgerhof (DE); Alfred Leinenbach, Ludwigshafen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/399,141

(22) PCT Filed: Oct. 11, 2001
(86) PCT No.: PCT/EP01/11761

(30) Foreign Application Priority Data
Oct. 13, 2000 (DE) 10050958.4

(51) Int. Cl. C11D 3/37

(52) U.S. Cl. 510/475; 510/480

(57) ABSTRACT

Use of water-soluble of water-dispersible, film-forming graft polymers obtainable by free-radical polymerization of

(a) vinyl esters of aliphatic C₁-C₂₄ carboxylic acids in the presence of

(b) polyethers with an average molecular weight (number average) of at least 300,

as coating compositions for particulate laundry detergents and cleaning products and as packaging material for laundry detergents, cleaning products, and laundry aftertreatment compositions for producing individual portions for dosing the products in the washing process together with the packaging material.

The invention relates to the use of water-soluble or water-dispersible graft polymers containing polyether blocks as coating compositions for particulate laundry detergents and cleaning products and as packaging material for laundry detergents, cleaning products, and laundry aftertreatment compositions for producing individual portions for dosing the products in the washing process together with the packaging material.

The portioned packaging of laundry detergents and cleaning products has been carried out using, for example, films made of water-soluble polymers such as polyvinyl alcohol or mixtures of polyvinyl alcohol, which is obtainable by from 85 to 90% hydrolysis of polyvinyl acetate, and acrylic acid; cf. JP-A-61-057 700 and DE-A-31 48 931. For instance, laundry detergents, for example, are packaged in film pouches made of the abovementioned polymers and are placed in the washing machine in the form of individual sealed packs. On contact with water, the film pouches disintegrate and release the laundry detergent they contain. Films of polyvinyl alcohol, however, have the disadvantage that in a moist environment they stick to one another, especially when two or more polyvinyl alcohol pouches containing a laundry detergent are lying one above another.

In order to reduce the stickiness of water-soluble films of polyvinyl alcohol for the packaging of laundry detergents and cleaning products it is known from EP-A-0 479 404 to combine a base film of polyvinyl alcohol on at least one surface with a second polymer material which is less water-soluble than polyvinyl alcohol and is in the form of a discontinuous, at least partly nonparticulate layer on at least the outer face of the film.

The use of polyvinyl alcohol as a packaging film has the disadvantage that the polyvinyl alcohol does not always dissolve completely in the washing liquor, tends to form gel, and deposits on the laundry. Moreover, polyvinyl alcohol has a slow dissolution rate and, if the ambient moisture content is low, tends toward embrittlement and a dramatic decrease in flexibility. Consequently, it is common to add plasticizers in the form of low molecular mass compounds to polyvinyl alcohol.

These necessary plasticizers in many cases pass from the wrapper into the contents, where they lead to changes. The plasticizer-depleted wrapper becomes brittle and unstable in the course of storage.

For the portioned metering of laundry detergents, EP-A-0 253 566 discloses film pouches which contain a laundry detergent and whose wall material consists of a composite of polyethylene oxides and a water-insoluble but water-permeable material, e.g., a nonwoven. This type of laundry detergent dosing has the disadvantage that the water-insoluble constituent of the packaging material has to be removed from the laundry following each wash.

DE-B-1 077 430 discloses a process for preparing graft polymers of vinyl esters, in which polyalkylene glycols and/or derivatives thereof are dissolved in at least one vinyl ester, in the presence or absence of further solvents, and the solution is subjected to free-radical polymerization. The graft polymers are used in the textile industry, as tackifiers and adhesives, in the leather industry, as a base material for the coatings industry, in the photographic industry, and as haircare materials.

DE-B-1 081 229 discloses a process for preparing water-soluble modified polyvinyl alcohols consisting of at least 50% by weight of polyvinyl alcohol units. They are prepared by subjecting graft polymers of at least one vinyl ester on polyalkylene glycols to full or partial saponification in the acidic or alkaline pH range. The polyalkylene glycol fraction in the graft polymer is from 0.1 to 50% by weight. The modified polyvinyl alcohols are loose powders with little or no color which dissolve readily in water. They are used, for example, to produce water-soluble packaging films, as sizing and finishing agents, and for cosmetic articles.

DE-B-1 094 457 discloses modified polyvinyl alcohols consisting of a graft polymer of at least one vinyl ester and, if desired, other monomers copolymerizable therewith on polyalkylene glycols, the graft polymer having been saponified to an extent such that the resulting modified polyvinyl alcohol is soluble even in cold water but contains less than 50% by weight of polyvinyl alcohol units. The modified polymers are suitable as protective colloids for the preparation of polymer dispersions and as starting materials for the production of foams. They are used, furthermore, as materials for the production of soft, readily water-soluble, transparent films, as sizing and finishing compositions and in cosmetology.

U.S. Pat. No. 4,746,456 discloses the use of graft polymers prepared by grafting polyalkylene oxides with vinyl acetate, up to 15% of the vinyl acetate units of said graft polymers having been saponified, if desired, as graying inhibitors in the washing and after treating of textile material containing synthetic fibers.

WO-A-00/18375 discloses the use of graft polymers of vinyl esters on the polyethers defined in more detail therein, such as polyalkylene glycols, as coating compositions, binders and/or film-forming auxiliaries in drug administration forms.

It is an object of the present invention to avoid skin contact by the user with the products during the dosing of laundry detergents, cleaning products and laundry aftertreatment compositions and for portioned dosing of the products to provide a packaging material which in the washing machine, on contact with water, releases the product and is dispersible or soluble in water.

We have found that this object is achieved in accordance with the invention by the use of water-soluble or water-dispersible, film-forming graft polymers obtainable by free-radical polymerization of

(a) vinyl esters of aliphatic C₁-C₂₄ carboxylic acids in the presence of

(b) polyethers with an average molecular weight (number average) of at least 300, of the formula I

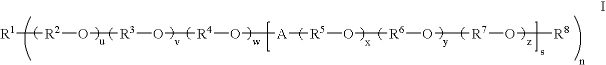

where

R¹ is hydroxyl, amino, C₁-C₂₄ alkyl, R⁹—COO—, R⁹—NH—COO—, polyalcohol residue;

R⁸ is hydrogen, amino-C₁-C₆ alkyl, C₁-C₂₄-alkoxy, R⁹—CO—, R⁹—NH—CO—;

R² to R⁷ are

—(CH₂)₂—, —(CH₂)₃—, —(CH₂)₄—, —CH₂—CH(CH₃)—, —CH₂—CH(CH₂—CH₃)—, —CH₂—CHOR¹⁰—CH₂—;

R⁹ is C₁-C₂₄ alkyl;

R¹⁰ is hydrogen, C₁-C₂₄ alkyl, R⁹—CO—;

A is —CO—O—, —CO—B—CO—O—, —CO—NH—B—NH—CO—O;

B is —(CH₂)ₜ—, unsubstituted or substituted arylene;

n is 1 or, if R¹ is a polyalcohol residue, from 1 to 8;

s is from 0 to 500;

t is from 1 to 12;

u is from 1 to 5000;

v is from 0 to 5000;

w is from 0 to 5000;

x is from 1 to 5000;

y is from 0 to 5000;

z is from 0 to 5000

as coating compositions for particulate laundry detergents and cleaning products and as packaging material for laundry detergents, cleaning products, and laundry aftertreatment compositions for producing individual portions for dosing the products in the washing process together with the packaging material.

Graft polymers of this kind are known from the cited prior art WO-A-00/18375. The graft base (b) used comprises, generally, polyethers of the formula I selected from the group consisting of polyalkylene oxides based on ethylene oxide, propylene oxide, and butylene oxide, polytetrahydrofuran, and polyglycerol. Depending on the nature of the monomer units, polymers having the following structural units are formed:

—(CH₂)₂—O—, —(CH₂)₃—O—, —(CH₂)₄—O—, —(CH₂)₄—O—, —CH₂—CH(CH₃)—O—, —CH₂—CH(CH₂—CH₃)—O—, —CH₂—CHOR¹⁰—CH₂—O—;

and may be homopolymers or copolymers, it being possible for the copolymers to be distributed randomly or to be in the form of block polymers.

Depending on the degree of grafting, the polymers used in accordance with the invention embrace both straight graft polymers and mixtures of the above graft polymers with ungrafted polyethers of the formula I and homopolymers or copolymers of the vinyl esters a) and, if used, further comonomers c).

The terminal primary hydroxyl groups of the polyethers prepared on the basis of alkylene oxides or glycerol, and the secondary OH groups of polyglycerol, may be either free or else etherified on one or both sides with C₁-C₂₄-alcohols or esterified with C₁-C₂₄-carboxylic acids. Alternatively, they may have been substituted for primary amino groups by reductive amination with hydrogen/ammonia mixtures under superatmospheric pressure or may have been converted into amino propyl endgroups by cyanoethylation with acrylonitrile and hydrogenation.

Alkyl radicals that may be mentioned for R¹ and R⁸ to R¹⁰ include branched or unbranched C₁-C₂₄ alkyl chains, preferably methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-ethylhexyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl or n-eicosyl.

Preferred representatives of the abovementioned alkyl radicals that may be mentioned are branched or unbranched C₁-C₁₂ alkyl chains, particularly preferably C₁-C₆ alkyl radicals.

The average molecular weight (number average) of the polyethers (b) is at least 300:and is usually <500000. It is preferably from 500 to 100000, with particular preference from 500 to 50000, with very particular preference from 800 to 15000, and in particular from 1000 to 10000.

It is advantageous to use homopolymers of ethylene oxide or copolymers having an ethylene oxide fraction of from 40 to 99% by weight. For the ethylene oxide polymers to be used with preference, therefore, the fraction of copolymerized ethylene oxide is from 40 to 100 mol %. Possible comonomers for these copolymers include propylene oxide, butylene oxide and/or isobutylene oxide. Examples of suitable copolymers are those of ethylene oxide and propylene oxide, ethylene oxide and butylene oxide and/or isobutylene oxide, and ethylene oxide, propylene oxide and butylene oxide or isobutylene oxide. The copolymers preferably contain from 40 to 99 mol % of ethylene oxide and from 15 1 to 60 mol % of propylene oxide or from 1 to 30 mol % of butylene oxide or from 1 to 60 mol % of propylene oxide and (iso)butylene oxide.

Besides straight-chain examples, branched homopolymers or copolymers may also be used as graft base.

Branched polymers may be prepared by adding disaccharides, ethylene oxide and, if desired, also propylene oxide and/or butylene oxides or polyglycerol, for example onto low molecular mass polyalcohols (i.e., R¹ in the formula I), e.g. pentaerythritol, glycerol and sugars or sugar alcohols such as sucrose, D-sorbitol and D-mannitol.

In this case polymers may be formed in which at least one, preferably from one to eight, with particular preference from one to five, of the hydroxyl groups present in the polyalcohol molecule may be linked in the form of an ether bond to the following polyether radical in accordance with formula I.

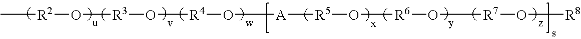

Within the polymer, the alkylene oxide units may be distributed randomly or may be in the form of blocks.

It is also possible, however, for the graft base used to comprise polyesters of polyalkylene oxides and aliphatic C₁-C₁₂, preferably C₁-C₆ diisocyanates or aromatic dicarboxylic acids, e.g. oxalic acid, succinic acid, adipic acid or terephthalic acid, having average molecular weights of from 1500 to 25000, described in EP-A-0 743 962.

It is also possible for the graft base used to comprise polycarbonates of polyalkylene oxides, prepared by phosgenation, and aliphatic C₁-C₁₂, preferably C₁-C₆, diisocyanates or aromatic diisocyanates, e.g., hexamethylenediisocyanate or phenylenediisocyanate.

The abovementioned polyesters, polycarbonates or polyurethanes may contain up to 500, preferably up to 100, polyalkylene oxide units, said polyalkylene oxide units consisting either of homopolymers or of copolymers of different alkylene oxides.

It is preferred to use polymers obtainable by polymerizing

a) at least one vinyl ester of aliphatic C₁-C₂₄ carboxylic acids in the presence of

b) polyethers with an average molecular weight (number average) of from 500 to 100000, of the formula Ia,

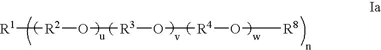

where:

R¹ is hydroxyl, amino, C₁-C₂₄ alkoxy, R⁹—COO—, R⁹—NH—COO, polyalcohol residue,

R⁸ is hydrogen, amino-C₁-C₆-alkyl, C₁-C₂₄ alkyl, R⁹—CO—, R⁹—NH—CO;

R² to R⁴ are

—(CH₂)₂—, —(CH₂)₃—, —(CH₂)₄—, —CH₂—CH(CH₃)—, —CH₂—CH(CH₂—CH₃)—, —CH₂—CHOR¹⁰—CH₂—;

R⁹ is C₁-C₂₄ alkyl;

R¹⁰ is hydrogen, C₁-C₂₄ alkyl, R⁹—CO—;

n is 1 or, if R¹ is a polyalcohol residue, 1 to 8;

u is 1 to 5000;

v is 0 to 5000;

w is 0 to 5000.

It is particularly preferred to use polymers obtainable by polymerizing

a) at least one vinyl ester of aliphatic C₁-C₁₂ carboxylic acids in the presence of

b) polyethers of an average molecular weight (number average) of from 500 to 50000 of the formula Ia, where

R¹ is hydroxyl, C₁-C₁₂ alkoxy, polyalcohol residue;

R⁸ is hydrogen, C₁-C₁₂ alkyl;

R² to R⁴ are

—(CH₂)₂—, —(CH₂)₃—, —(CH₂)₄—, —CH₂—CH(CH₃)—, —CH₂—CH (CH₂—CH₃)—, —CH₂—CHOR¹⁰—CH₂—;

R¹⁰ is hydrogen, C₁-C₁₂ alkyl;

n is 1 or, if R¹ is a polyalcohol residue, from 1 to 5;

u is from 2 to 2000;

v is from 0 to 2000;

w is from 0 to 2000.

Very particular preference is given to using polymers obtainable by polymerizing

a) at least one vinyl ester of aliphatic C₁-C₆ carboxylic acids, especially vinyl acetate, in the presence of

b) polyethers of an average molecular weight (number average) of from 1000 to 10000 of the formula Ia, where

R¹ is hydroxyl, C₁-C₆-alkoxy, especially hydroxyl;

R⁸ is hydrogen, C₁-C₆ alkyl, especially hydrogen;

R² to R⁴ are

—(CH₂)₂—, —(CH₂)₃—, —CH₂—CH(CH₃)—, —CH₂—CHOR¹⁰—CH₂13 , especially —(CH₂)₂—;

R¹⁰ is hydrogen, C₁-C₆ alkyl;

n is 1;

u is from 5 to 500;

v is from 0 to 500, especially 0;

w is from 0 to 500, especially 0.

For the polymerization in the presence of the polyethers of the formula I, the following copolymerizable monomers may be mentioned as component a):

Vinyl esters of aliphatic, saturated or unsaturated C₁-C₂₄ carboxylic acids, such as formic acid, acetic acid, propionic acid, butyric acid, valeric acid, isovaleric acid, caproic acid, caprylic acid, capric acid, undecylenic acid, lauric acid, myristic acid, palmitic acid, palmitoleic acid, stearic acid, oleic acid, arachidic acid, behenic acid, lignoceric acid, cerotic acid, and melissic acid.

It is preferred to use vinyl esters of the abovementioned C₁-C₁₂ carboxylic acids, especially the C₁-C₆ carboxylic acids, above all of acetic acid.

It is of course also possible for mixtures of the respective monomers from group a) to be graft-polymerized.

Additionally, the vinyl esters (a) may also be used as a mixture of one or more comonomers (c). The comonomers (c) may be hydrophobic or hydrophilic; also suitable are the compounds commonly used as crosslinkers. The fraction of these additional monomers (c) in the mixture of (a)+(c) should be restricted to from 0.1 to 30% by weight. Preference is given to fractions of from 1 to 20% by weight of the comonomers (c) in the mixture.

Suitable hydrophobic comonomers (c) may be selected from the following groups; it is of course also possible to use mixtures of the monomers:

(c₁) C₁-C₂₄ alkyl esters of monoethylenically unsaturated C₃-C₈ carboxylic acids;

(c₂) C₁-C₂₄ hydroxyalkyl esters of monethylenically unsaturated C₃-C₈ carboxylic acids;

(c₃) C₁-C₂₄ alkyl vinyl ethers;

(c₄) N-vinyl lactams;

(c₅) monoethylenically unsaturated C₃-C₈ carboxylic acids.

Examples of suitable monoethylenically unsaturated C₃-C₈ carboxylic acids are acrylic acid, methacrylic acid, maleic acid, fumaric acid, itaconic acid, and aconitic acid.

As examples of the alkyl radicals, refer to the abovementioned C₁-C₂₄ alkyl radicals and their hydroxylation products. Preference is given here to the mention of branched or unbranched C₁-C₄ alkyl radicals, especially methyl, ethyl, n-propyl, 1-methylethyl, n-butyl, 1-methylpropyl, 2-methylpropyl, 1,1-dimethylethyl, and their hydroxylation products.

Particular preference is given to monomers from groups (c₁) to (c₃). Very particular preference is given to methyl (meth)acrylate, ethyl (meth)acrylate, hydroxymethyl (meth)acrylate, 2-hydroxyethyl (meth)acrylate, methyl vinyl ether and ethyl vinyl ether.

Suitable hydrophilic comonomers (c) are, for example, monoethylenically unsaturated C₃-C₈ carboxylic acids such as acrylic acid, methacrylic acid, maleic acid, fumaric acid, itaconic acid, and aconitic acid, and also N-vinyl lactams, such as N-vinylpyrrolidone, N-vinylimidazole or N-vinylcaprolactam.

Preferred hydrophilic comonomers (c) are acrylic acid, methacrylic acid, and N-vinylpyrrolidone.

Suitable comonomers (c) normally used as crosslinkers are compounds which contain in their molecule at least two ethylenically unsaturated, nonconjugated double bonds. Preferred examples are alkylenebisacrylamides, such as methylenebisacrylamide and N,N′-acryloylethylenediamine, vinylalkyleneureas, such as N,N′-divinylethyleneurea and N,N′-divinylpropyleneurea, ethylidenebis-3-(N-vinylpyrrolidone), N,N′-divinylimidazolyl(2,2′)butane, 1,1′-bis(3,3′-vinylbenz-imidazolid-2-one)-1,4-butane, alkylene glycol di(meth)acrylates, such as ethylene glycol di(meth)acrylate, tetraethylene glycol di(meth)acrylate, and diethylene glycol di(meth)acrylate, aromatic divinyl compounds,.such as divinylbenzene and divinyltoluene, and also vinyl acrylate, allyl (meth)acrylate, divinyldioxane, pentaerythritol triallyl ether, and triallylamines.

Graft polymers whose graft base is a polyglycerol are obtainable by polymerizing

a) at least one vinyl ester of aliphatic C₁-C₂₄ carboxylic acids in the presence of

b) polyglycerol of the formula Ib,

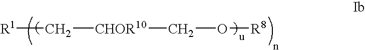

where

R¹ is hydroxyl, C₁-C₂₄ alkoxy, R⁹—COO—, polyalcohol residue;

R⁸ and R¹⁰ are hydrogen, C₁-C₂₄ alkyl, R⁹—CO—;

R⁹ is C₁-C₂₄ alkyl;

n is 1 or, if R¹ is a polyalcohol residue, from 1 to 8;

u is from 1 to 2000.

Particularly preferred graft polymers on polyglycerols are obtainable by polymerizing

a) at least one vinyl ester of aliphatic C₁-C₆ carboxylic acids in the presence of

b) polyglycerol of the formula Ib where

R¹ is hydroxyl, C₁-C₆ alkoxy;

R⁸ and R¹⁰ are hydrogen, C₁-C₆ alkyl;

n is 1;

u is from 1 to 100.

Besides linear polyglycerols, it is also possible to use branched and/or cyclic polyglycerols as graft base.

The graft polymers based on polyglycerol may if desired contain in copolymerized form, in addition to the vinyl esters (a), at least one further comonomer (c), already mentioned above.

Preferred comonomers c) are C₁-C₆ alkyl esters of monoalkylenically unsaturated C₃-C₈ carboxylic acids, N-vinylpyrrolidone, N-vinylimidazole, N-vinylcaprolactam, and (meth)acrylic acid.

The K values of the graft polymers are, for example, in the range from 10 to 200, preferably in the range from 15 to 150, with particular preference in the range from 15 to 100, with very particular preference in the range from 20 to 80. The particular K value desired may be set in a conventional manner through the composition of the starting materials. The K values are determined by the method of H. Fikentscher, Cellulose-Chemie 13 (1932) 58 to 64 and 71 to 74, in N-methylpyrrolidone at 25° C. and polymer concentrations which depending on K value range are from 0.1% by weight to 5% by weight.

To prepare the graft polymers, the vinylesters (a) and, if desired, the comonomers (c) may be polymerized in the presence of the polyethers (b) as graft base both with the aid of free-radical-forming initiators and by exposure to high-energy radiation, a term which is intended to include exposure to high-energy electrons as well.

The polymerization may, for example, be a solution polymerization, bulk polymerization, emulsion polymerization, inverted emulsion polymerization, suspension polymerization, inverted suspension polymerization, or precipitation polymerization, although the methods which may be used are not restricted to these.

In the case of the bulk polymerization which is preferably carried out one possible procedure is to dissolve the polyether (b), especially the polyalkylene oxide (b), in at least one vinyl ester (a) and, if desired, one or more comonomers (c) and, after adding a polymerization initiator, to polymerize the mixture. The graft polymerization may also be carried out semicontinuously, by first introducing as an initial charge a portion, e.g., 10% by weight, of this mixture and heating the mixture to polymerization temperature, and, following the onset of the polymerization, adding the remainder of the polymerization mixture in accordance with the progress of the polymerization. The graft polymers may also be obtained by charging the polyethers (b) to a reactor, heating them to the polymerization temperature, and adding at least one vinyl ester (a) and, if desired comonomer (c) (separate or as a mixture) and polymerization initiator either all at once, in portions or, preferably, continuously, and polymerizing the batch.

The quantitative ratio of the polyethers (b) used as graft base to the vinyl esters (a) or the mixture of the vinyl esters (a) and the comonomers (c), is in the range from 1:0.5 to 1:50, preferably in the range from 1:1.5 to 1:35, and with particular preference in the range from 1:2 to 1:30.

Particularly suitable polymerization initiators are organic peroxides, such as diacetyl peroxide, dibenzoyl peroxide, succinyl peroxide, di-tert-butyl peroxide, tert-butyl perbenzoate, tert-butyl perpivalate, tert-butyl permaleate, cumene hydroperoxide, diisopropyl peroxydicarbonate, bis(o-tolyl) peroxide, didecanoyl peroxide, dioctanoyl peroxide, dilauroyl peroxide, tert-butyl perisobutyrate, tert-butyl peracetate, di-tert-amyl peroxide, tert-butyl hydroperoxide, and mixtures of the abovementioned initiators, redox initiators, and azo initiators.

The amounts of initiator or initiator mixtures used, based on monomer (a) and, if required, (c) used, are from 0.01 to 10% by weight, preferably from 0.3 to 5% by weight.

The graft polymerization takes place in the temperature range from 40 to 200° C., preferably in the range from 50 to 140° C., with particular preference in the range from 60 to 110° C. It is normally carried out under atmospheric pressure but may also take place under subatmospheric or superatmospheric pressure, preferably at from 1 to 5 bar.

If desired, the above-described graft polymerization may also be carried out in a solvent or solvent mixture. Examples of suitable solvents are aliphatic and cycloaliphatic monohydric alcohols, such as methanol, ethanol, n-propanol, isopropanol, n-butanol, sec-butanol, tert-butanol, n-hexanol and cyclohexanol, polyhydric alcohols, e.g., glycols, such as ethylene glycol, propylene glycol and butylene glycol, and glycerol. Alkyl ethers of polyhydric alcohols, e.g., methyl or ethyl ethers of the dihydric alcohols, ether alcohols, such as diethylene glycol and triethylene glycol, and cyclic ethers, such as dioxane.

The graft polymerization may also be carried out in water as solvent. Where water-insoluble products formed during the polymerization are to be obtained directly in dissolved form, it is possible to add water-miscible organic solvents during the polymerization, examples being monohydric alcohols having from 1 to 3 carbon atoms, acetone or dimethyl formamide.

Alternatively, the graft polymerization in water may be conducted such that the water-insoluble graft polymers are converted into the form of a fine dispersion by adding customary emulsifiers or protective colloids, e.g., polyvinyl alcohol. Examples of emulsifiers used are ionic or nonionic surfactants whose HLB is in the range from 3 to 13. For the definition of HLB, reference is made to the publication by W. C. Griffin, J. Soc. Cosmetic Chem. 5 (1954) 249. If surfactants are used during the graft polymerization, the amount of surfactants, based on the graft copolymer, is, for example, from 0.1 to 5% by weight.

It is common to use from 5 to 200% by weight, preferably from 10 to 100% by weight, of organic solvent, water, or mixture of water and organic solvent, based on the graft polymer.

In order to increase the hydrophilicity of the graft polymers used in accordance with the invention it is possible to saponify (hydrolyze) some or all of the ester groups following the polymerization. The saponification takes place in conventional manner by adding a base, preferably an alcoholic alkali metal hydroxide solution, especially a methanolic sodium or potassium hydroxide solution at temperatures in the range from 10 to 70° C., preferably in the range from 15 to 30° C.

The degree of saponification depends on the amount of base used, on the saponification temperature, and on the saponification time and may correspondingly be in the range from 0 to 100 mol %. It is preferably in the range from 20 to 100 mol %, with particular preference in the range from 40 to 100%, in particular from 65 to 100 mol %, and with very particular preference in the range from 80 to 100 mol %.

The solids content of the aqueous polymer dispersions or solutions resulting after the alcohol is exchanged for water (e.g., by steam distillation) is generally from 10 to 70% by weight, preferably from 15 to 65% by weight, with particular preference from 20 to 60% by weight.

Depending on the degree of saponification and concentration, aqueous dispersions or solutions of the graft polymers used in accordance with the invention are obtained with a viscosity of less than 1000 mPas. At a polymer concentration of 20% by weight, the viscosity is preferably from 5 to 400 mPas, with particular preference from 10 to 250 mPas.

The graft polymer dispersions or solutions may be converted into powder form by a variety of drying methods, such as spray drying, fluidized spray drying, roll drying, or freeze drying, for example. Owing to the low viscosity of the solutions or dispersions, the preferred drying technique used is spray drying. An aqueous dispersion or solution may be prepared again by introducing the resulting dry graft polymer powder into water. Pulverulent graft polymers have the advantage over dispersions and solutions, especially aqueous dispersions and solutions, of better storage properties, greater ease of transport, and less of a tendency toward microbial infestation.

The graft polymers may be applied in pure form or else together with the customary auxiliaries to an active substance core, e.g., to tablets of a laundry detergent or cleaning product. Examples of customary auxiliaries are color pigments for coloring, white pigments, such as titanium dioxide, for increasing the hiding power, talc and silica as antistick agents, polyethylene glycols, glycerol, propylene glycol, triacetin, triethyl citrate as plasticizers, and various surface-active substances, such as sodium lauryl sulfate, for improving the wetting properties.

It is further possible to combine the graft polymers for use in accordance with the invention with other film formers and/or polymers in a ratio, for example, of from 1:9 to 9:1. Examples which may be used for this purpose are the following polymers:

polyvinylpyrrolidone, polyvinylpyrrolidone copolymers, water-soluble cellulose derivatives, such as hydroxypropylcellulose, hydroxypropylmethylcellulose, methylcellulose and hydroxyethylcellulose, acrylate and methacrylate copolymers, polyvinyl alcohols, polyethylene glycols and polyethylene oxide-polypropylene oxide block polymers. Melts of such polymer mixtures may be processed, for example, into films, granules or powders. The films may be used directly for packaging laundry detergents and cleaning products.

The coating of particulate laundry detergents and cleaning products is desirable since it prevents contact between constituents of the laundry detergents or cleaning products and the skin of the user during the customary dosing of these products in the household. This advantage applies in particular to those laundry detergents and cleaning products which include constituents which may lead to irritation or allergic reactions of the skin, examples being alkali metal carbonates, oxidizing agents such as perborates, or enzymes. The coating of particulate laundry detergents and cleaning products has the advantage, moreover, that the fracture strength and the abrasion of the coated particles is improved over that of uncoated particles of identical composition.

By particulate laundry detergents and cleaning products there should be understood all customary commercial forms of these products, e.g., granules, pellets, flakes, strands, beads, tablets, and powders. Some examples of the composition of laundry detergents and cleaning products (including bleaches) are given in tables 1 and 2. In the case of the laundry detergents, they may comprise customary powder detergents or compact detergents having a bulk density of, for example, from 550 to 1000 g/l.

TABLE 1

| | Compact laundry | | | | | | | | | |
|---|---|---|---|---|---|---|---|---|---|---|
| | detergent powders | | | | Laundry detergent tablets | | | | | |
| Composition No. | 1 | 2 | 3 | 4 | 5 | 6 | 7 | 8 | 9 | 10 |
| Alkylbenzene sulfonate (LAS) | 6 | 8 | 12 | 12 | 9 | 9 | 2 | 11.5 | 9 | 10 |
| Fatty alcohol sulfate (FAS) | 8 | | 5 | 6 | | | 12 | 4.5 | 7 | 4 |
| Soap | 1.5 | 1.5 | 2 | 2 | 1 | 1 | 2 | 1.5 | 1.5 | 1.5 |
| Fatty alcohol ethoxylate | 5 | 7.5 | 8 | 12 | 3 | 6 | 5 | 1 | 3.5 | 6 |
| (nonionic) | | | | | | | | | | |
| Fatty acid glucamide | 1 | | | | | | 1 | | | |
| Cationic surfactant | 5 | | | | | | 5 | | | |
| Pentasodium triphosphate | | | | | 45 | | | | | |
| (STP) | | | | | | | | | | |
| Zeolite A | 20 | | 27 | 40 | | | 13 | 8 | 32 | 30 |
| Phyllosilicate SKS 6 | 15 | | | | | | 12 | | | |
| Zeolite P | | 30 | | | 0.5 | 22 | | | | |
| Sodium carbonate | 6 | 20 | 7 | 1 | 3 | 2.5 | 10 | 26 | 10 | 11 |
| Sodium metasilicate | | 7 | | 3 | 5 | 6 | | | 5 | 7.5 |
| Sodium citrate | 3 | | 3 | 12 | | | 5 | | 4 | 7.5 |
| Borax | | | | | | | | | 0.5 | |
| Sodium perborate × 2 H₂O | | | 13 | | | | | | | |
| Sodium percarbonate | 17 | 20 | | | 17 | 14 | 10 | 15 | 16 | |
| Bleach activator (TAED) | 4 | 3.5 | 5 | | 2.5 | 4 | 5 | 5.5 | 4.5 | |
| Complexing agent | 0.4 | 0.3 | 0.3 | | 0.7 | 0.5 | 0.2 | 0.2 | 0.3 | 0.7 |
| Polycarboxylate (Sokalan ® | 3 | 2 | 5 | 5 | 2 | 4 | 2 | 4 | 4.5 | 5 |
| CP 5) | | | | | | | | | | |
| Polyvinylpyrrolidone (Sokalan | | | | 0.5 | | | | | | 0.6 |
| HP 53) | | | | | | | | | | |
| Soil Release Polyester | 2 | | | 3 | | | | 1.6 | | |
| (Sokalan SR 100) | | | | | | | | | | |
| Enzymes | + | + | + | + | + | + | + | + | + | + |
| Sodium acetate | | | | | | 20 | 6 | | | |
| Monoethanolamine | | | | | | | | | | |
| Solubilizer | | | | | | | | | | |
| Water | | | | | | | | | | |
| Sodium sulfate | rest | rest | rest | rest | rest | rest | rest | rest | rest | rest |
| | to | to | to | to | to | to | to | to | to | to |
| | 100 | 100 | 100 | 100 | 100 | 100 | 100 | 100 | 100 | 100 |

TABLE 2

| | Dishwashing | | | Dishwashing | | | Liquid laundry | | | Scouring |
|---|---|---|---|---|---|---|---|---|---|---|
| | detergent | | | detergent | | | detergent | | | salt |
| | powders | | | Tablets | | | Concentrates | | | Tablet |
| Composition No. | 11 | 12 | 13 | 14 | 15 | 16 | 17 | 18 | 19 | 20 |
| Alkylbenzene sulfonate | | | | | | | | | | |
| (LAS) | | | | | | | | | | |
| Fatty alcohol sulfate | | | | | | | 15 | 12 | 6 | |
| (FAS) | | | | | | | | | | |
| Soap | | | | | | | 10 | | 16 | |
| Fatty alcohol | 1* | 0.5* | 1* | 7* | 0.4* | 4.5* | 6 | 6 | 25 | 2.5 |
| ethoxylate (nonionic) | | | | | | | | | | |
| Fatty acid glucamide | | | | | | | 4 | | | |
| Cationic surfactant | | | | | | | 5 | | | |
| Pentasodium | | 30 | 40 | 45 | 50 | 20 | | 20 | | |
| triphosphate (STP) | | | | | | | | | | |
| Zeolite A | | | | 0.2 | | | | | | |
| Phyllosilicate SKS 6 | | | | | | | | | | |
| Zeolite P | | | | | | | | | | |
| Sodium carbonate | 14 | 35 | 27 | 15 | 20 | 9 | | 1 | | 40 |
| Sodium metasilicate | 10 | 3 | 5 | 10 | 5 | 1 | | | | 4.5 |
| Sodium citrate | 15 | | | 10 | | 45 | 7 | 1 | 7 | 28 |
| Borax | 1.5 | | 0.6 | 4.5 | 1.5 | 1 | 2 | 1.5 | 0.8 | |
| Sodium perborate × 2 H2O | 9 | | 5 | 4.5 | 10 | 11 | | | | |
| Sodium percarbonate | | 4 | | | | | | | | 15 |
| Bleach activator (TAED) | 1.5 | 0.8 | | 2.5 | 1.5 | 0.5 | | | | 7 |
| Complexing agent | 0.2 | | | 0.2 | 0.3 | 0.8 | 0.4 | 0.8 | 0.6 | 0.2 |
| Polycarboxylate (Sokalan ® | 3 | | | 1 | 1.5 | | | | | 1.5 |
| CP 5) | | | | | | | | | | |
| Polyvinylpyrrolidone | | | | | | | | 0.1 | | |
| (Sokalan HP 53) | | | | | | | | | | |
| Soil Release Polyester | | | | | | | | | | |
| (Sokalan SR 100) | | | | | | | | | | |
| Enzymes | + | + | + | + | + | + | + | + | + | + |
| Sodium acetate | | | | | | | | | | |
| Monoethanolamine | | | | | | | 7 | | | |
| Solubilizer | | | | | | | 10 | 2.5 | 2 | |
| Water | | | | | | | 33.6 | 55.1 | 42.6 | |
| Sodium sulfate | rest | rest | rest | rest | rest | rest | | | | rest to |
| | to | to | to | to | to | to | | | | 100 |
| | 100 | 100 | 100 | 100 | 100 | 100 | | | | |

*Fatty alcohol × EO × PO

For the coating of particulate laundry detergents and cleaning products it is possible to employ the conventional processes, examples being coating in a fluidized bed or in a horizontal drum coater, dip-coating processes and pan-coating processes. Coating is preferably carried out on laundry detergent tablets, cleaning product tablets, and also beads, granules and those forms of laundry and cleaning formulations of which, for example, from 1 to 5 shaped bodies such as tablets or beads are required for one wash.

The coating compositions are applied, for example, in a thickness of from 5 to 1000 μm, preferably from 30 to 500 μm and in particular in a thickness of from 40 to 100 μm, to the particulate laundry detergents and cleaning products.

The invention further provides for the use of the above-described graft polymers as packaging material for laundry detergents, cleaning products, and laundry aftertreatment compositions for producing individual portions for dosing the products in the washing process together with the packaging material. The amount of laundry detergent, cleaning product or laundry aftertreatment composition packaged and portioned individually for one wash in each case is referred to in the literature, for example, as single pack, unit packaging detergent, or sachets for packaging measured portions of detergents.

From the graft polymers for use in accordance with the invention it is possible, as already described above, to produce films, by extrusion or by casting, for example. The thickness of the films is, for example, from 10 to 1000 μm, preferably from 30 to 500 μm, and in the majority of cases is in the range from 40 to 100 μm. The water-soluble graft polymer films are used to produce, for example, pouches or bags for the packaging of pulverulent laundry detergents, liquid laundry detergents, cleaning products, and laundry aftertreatment compositions. After they have been filled with one of the aforementioned products, the pouches or bags are closed by, for example, welding, sealing, or bonding with the aid of an adhesive. The amount of active product packaged in each of the pouches is preferably such that, for example, from 1 to 5 pouches, in particular one pouch, are or is sufficient for a single wash. In some cases, depending on the water hardness, it may be necessary to dose 2 or more pouches, e.g. from 2 to 4, for one wash. On contact with water, the film pouch disintegrates, releasing the product packaged therein. The packaging material is very readily soluble in water or in the washing liquor or readily dispersible therein. With the aid of the laundry detergents, cleaning products and laundry care compositions packaged in individual portions it is possible to achieve optimum dosing of the products without the risk to the user of coming into contact with, say, alkaline constituents of a laundry detergent formulation.

Graft polymers used with preference are obtainable by polymerizing

(a) vinyl acetate in the-presence of

(b) polyalkylene oxides, polyalkylene oxides endgroup-capped at one end, and/or polyalkylene oxides endgroup-capped at both ends,

and hydrolyzing from 20 to 100 mol % of the vinyl acetate units.

Particular preference is given to those graft polymers obtainable by free-radical polymerization of

(a) vinyl acetate in the presence of

(b) polyethylene glycols with a molecular weight (number average) of from 500 to 100000, preferably from 1000 to 50000, and

hydrolysis of from 20 to 100 mol % of the vinyl acetate units of the graft polymers.

In the majority of cases, from 80 to 100 mol % of the vinyl acetate units of the preferred graft polymers are hydrolyzed.

The K values of the polymers were determined by the method of H. Fikentscher, Cellulose-Chemie 13, (1932) 58-64 and 71 to 74 in N-methylpyrrolidone at a temperature of 25° C. and a polymer concentration of 1% by weight.

### EXAMPLES

Preparing the Graft Polymers

Graft Polymer 1

A polymerization vessel was charged with 72 g of polyethylene glycol (average molecular weight 6000, Pluriol® E 6000) and this initial charge was heated to 80° C. with stirring under a gentle stream of nitrogen. Still with stirring, and maintaining the 80° C., a feed stream of 410 g of vinyl acetate was added dropwise over 3 h and at the same time a further feed stream of a solution of 1.4 g of tert-butyl perpivalate in 30 g of methanol was added dropwise likewise over 3 h. After all of the streams had been added, stirring was continued at 80° C. for 3 h. After cooling, the polymer was dissolved in 450 ml of methanol. For saponification, 50 ml of a 10% by weight strength methanolic sodium hydroxide solution were added at 30° C. After about 40 minutes, the reaction as terminated by adding 750 ml of 1% strength acetic acid. To remove the methanol, the solution was subjected to steam distillation. Subsequent freeze drying of the clear solution gave a white powder. A 20% strength aqueous solution of the resulting polymer had a viscosity of 124 mPas. The K value of the graft polymer was 54, the elongation at break 74%.

### Example 1

Producing Coated Tablets

An aqueous solution containing 20% by weight of graft polymer 1 and 0.5% by weight of Sicomet® Red P (BASF) was applied by spraying to 5000 g of commercial dishwashing detergent tablets Somat® Profi (from Henkel) in a horizontal drum coater (Accela-Cota 24 from Manesty). 625 g (including an additional 10% by weight for spraying losses) were applied to the tablets at an air entry temperature of 60° C. and a spraying rate of 30 g/min with a 1.0 mm wide spray nozzle and a spraying pressure of 2.0 bar. After the end of the spraying operation, the tablets sprayed with the solution were dried at 60° C. for 5 min. This gave tablets with a red coating, said tablets having the following properties:

| | |
|---|---|
| Appearance: | uniform granular surface |
| Handle: | Reduced surface roughness, more pleasant handle than |
| | uncoated tablets |
| Abrasion: | no abrasion on rubbing with the finger, 50 mg after |
| | 10 minutes of shaking in a rotary mixer (from |
| | Gerhardt) with 1 tablet in a screw-top jar (500 ml) |
| | for a tablet coated in accordance with Example 1, and |
| | 960 mg for an uncoated tablet. |

### Example 2

Producing Powder-Filled Water-Soluble Film Pouches

The graft polymer 1 was cast to produce a film having a thickness of 40 μm and a film having a thickness of 100 μm. 20 g of a commercially customary heavy-duty laundry detergent were welded into each film using a customary household film welder. The detergent-containing film pouches thus produced were each placed in a glass beaker filled with water (temperature 20° C.). Then a measurement was made of the time within which the pack (i.e. the graft polymer 1) dissolved without residue.

In the case of the pouch made of a film having a thickness of 40 μm, the dissolution time was 20 seconds; in the case of the pouch made of a film having a thickness of 100 μm, residueless dissolution took 60 seconds.

We claim:

1. The use of water-soluble or water-dispersible, film-forming graft polymers obtainable by free-radical polymerization of
(a) vinyl esters of aliphatic C₁-C₂₄ carboxylic acids in the presence of
(b) polyethers with an average molecular weight (number average) of at least 300, of the formula I 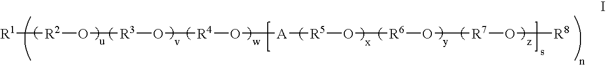
where
R¹ is hydroxyl, amino, C₁-C₂₄ alkoxy, R⁹—COO—, R⁹—NH—COO—, polyalcohol residue;
R⁸ is hydrogen, amino-C₁-C₆ alkyl, C₁-C₂₄ alkyl, R⁹—CO—, R⁹—NH'CO—;
R² to R⁷ are
—(CH₂)₂—, —(CH₂)₃—, —(CH₂)₄—, —CH₂—CH(CH₃)—, —CH₂—CH(CH₂—CH₃)—, —CH₂—CHOR¹⁰—CH₂—;
R⁹ is C₁-C₂₄ alkyl;
R¹⁰ is hydrogen, C₁-C₂₄ alkyl, R⁹—CO—;
A is —CO—O—, —CO—B—CO—O—, —CO—NH—B—NH—CO—O—;
B is —(CH₂)ₜ—, unsubstituted or substituted arylene;
n is 1 or, if R¹ is a polyalcohol residue, from 1 to 8;
s is from 0 to 500;
t is from 1 to 12;
u is from 1 to 5000;
v is from 0 to 5000;
w is from 0 to 5000;
x is from 1 to 5000;
y is from 0 to 5000;
z is from 0 to 5000
as coating compositions for particulate laundry detergents and cleaning products and as packaging material for laundry detergents, cleaning products, and laundry aftertreatment compositions for producing individual portions for dosing the products in the washing process together with the packaging material.

2. The use as claimed in claim 1, wherein the graft polymers are obtainable by polymerizing
(a) vinyl acetate in the presence of
(b) polyalkylene oxides, polyalkylene oxides endgroup-capped at one end, and/or polyalkylene oxides endgroup-capped at both ends.

3. The use as claimed in claim 1, wherein the graft polymers are obtainable by polymerizing
(a) vinyl acetate in the presence of
(b) polyethylene glycols with a molecular weight (number average) of from 500 to 100000.

4. The use as claimed in claims 1 to 3, wherein from 20 to 100 mol % of the vinyl acetate units of the graft polymers have been hydrolyzed.

5. The use as claimed in claims 1 to 4, wherein the polymerization is conducted in the presence of from 0.1 to 30% by weight of comonomers (c), based on the mixture of monomers (a) and comonomers (c).

6. The use as claimed in claims 1 to 5, wherein the graft polymers are used as packaging material in the form of films having a thickness of from 10 to 1000 μm.

7. The use as claimed in claims 1 to 6, wherein the graft polymers are used in the form of films having a thickness of from 30 to 500 μm.

8. The use as claimed in claims 1 to 5, wherein the graft polymers are used to coat laundry detergent tablets, laundry detergent granules, and cleaning product tablets.
